(19) United States
(12) Patent Application Publication
(10) Pub. No.: US 2012/0285484 A1
(43) Pub. Date: Nov. 15, 2012

(54) METHOD FOR CLEANING A SEMICONDUCTOR WAFER

(76) Inventors: Li-Chung Liu, Taichung City (TW); Yi-Nan Chen, Taipei City (TW); Hsien-Wen Liu, Taoyuan County (TW)

(21) Appl. No.: 13/106,869

(22) Filed: May 13, 2011

(51) Int. Cl. B08B 1/00

(52) U.S. Cl. 134/6

(57) ABSTRACT

A wafer cleaning method includes: (1) providing a wafer cleaning apparatus comprising a sponge for scrubbing a surface of a semiconductor wafer to be cleaned; (2) implementing a pre-conditioning flow to pre-condition the sponge using a dummy wafer; and (3) performing a regular cleaning flow to scrub the surface of the semiconductor wafer to be cleaned using the pre-conditioned sponge. The dummy wafer has a plurality of upward protruding features on a surface of the dummy wafer for removing residual fibers or unwanted substances from the sponge.

### BACKGROUND OF THE INVENTION

1. Field of the Invention

The present invention relates generally to a method for cleaning a workpiece. More particularly, the present invention relates to a method for cleaning a semiconductor wafer that requires a high degree of cleanliness.

2. Description of the Prior Art

As known in the art, chemical mechanical polishing (CMP) techniques have been widely used for planarizing material layers on semiconductor wafers. In chemical mechanical polishing, slurry is dispensed onto a polishing surface of a polishing pad. Relative movement between the polishing surface and the wafer produces a combined mechanical and chemical effect on the surface of the wafer. This process creates a highly level surface on the wafer.

After CMP, the wafer is transferred to a cleaning unit and may be scrubbed with a sponge of polyvinyl acetate (PVA) mounted on a brush head reciprocating along a predetermined route. Simultaneously, water with ultrasonic vibration energy may be supplied onto the surface of the wafer to reduce the number of particles on the semiconductor wafer. After a number of semiconductor wafers are cleaned by the sponge of PVA, particles are attached to or entrapped in the sponge of PVA which in turn contaminates subsequent semiconductor wafers. Therefore, the sponge of PVA does not have a long service life and has to be replaced after a period of time in order to maintain the cleaning performance and effectiveness.

However, the applicant has found that the newly replaced sponge of PVA exhibits poor cleaning effectiveness in an early stage, which would jeopardize the reliability and performance of the integrated circuits in the semiconductor wafers. Therefore, a need exists in this technical field to provide an improved method for cleaning semiconductors without incurring additional cost.

### SUMMARY OF THE INVENTION

It is one object of the present invention to provide an improved method for cleaning a semiconductor wafer in order to solve the above-mentioned prior art problems.

To these ends, according to one aspect of the present invention, there is provided a wafer cleaning method comprising: (1) providing a wafer cleaning apparatus comprising a sponge for scrubbing a surface of a semiconductor wafer to be cleaned; (2) implementing a pre-conditioning flow to pre-condition the sponge using a dummy wafer; and (3) performing a regular cleaning flow to scrub the surface of the semiconductor wafer to be cleaned using the pre-conditioned sponge. According to one embodiment, the pre-conditioning flow comprises: (1) loading the dummy wafer into the wafer cleaning apparatus; (2) rotating and rinsing the dummy wafer; and (3) pressing and scanning the sponge against the dummy wafer. The dummy wafer has a plurality of upward protruding features on a surface of the dummy wafer for removing residual fibers or unwanted substances from the sponge.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a schematic diagram illustrating parts of an exemplary scrubber for cleaning a surface of a semiconductor wafer, which are germane to this invention;

FIG. 2 is a flow chart showing a regular cleaning flow for cleaning the semiconductor wafer in accordance with one embodiment of this invention;

FIG. 3 is a flow chart showing a wafer cleaning method in accordance with one embodiment of this invention;

FIG. 4 is a schematic, cross-sectional diagram illustrating the pre-conditioning status of a newly replaced sponge of PVA using a specific dummy wafer in accordance with the preferred embodiment of this invention; and

FIG. 5 is a flow chart showing an exemplary pre-conditioning flow in accordance with the preferred embodiment of this invention.

It should be noted that all the figures are diagrammatic. Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

In the following description, numerous specific details are given to provide a thorough understanding of the invention. However, it will be apparent to one skilled in the art that the invention may be practiced without these specific details. In order to avoid obscuring the present invention, some well-known system configurations and process steps are not disclosed in detail. The drawings showing embodiments of the apparatus are semi-diagrammatic and not to scale and, particularly, some of the dimensions are for the clarity of presentation and are shown exaggerated in the figures.

The present invention pertains to an improved method for cleaning a workpiece such as a semiconductor wafer that requires a high degree of cleanliness. As previously described, a sponge of polyvinyl acetate (PVA) or a brush in a scrubber, which is used to scrub a surface of the semiconductor wafer, does not have a long service life and has to be replaced after a period of time in order to maintain the cleaning performance and effectiveness. The applicant has found that the newly replaced sponge of PVA or brush exhibits poor cleaning effectiveness in an early stage, which would jeopardize the reliability and performance of the integrated circuits in the semiconductor wafers. The applicant has found that the poor cleaning effectiveness in an early stage of a new sponge of PVA or brush may be partly due to the residual fiber adhered to the surface of the new sponge. It is believed that the residual fiber stems from the manufacturing process of the brush. This invention addresses this problem.

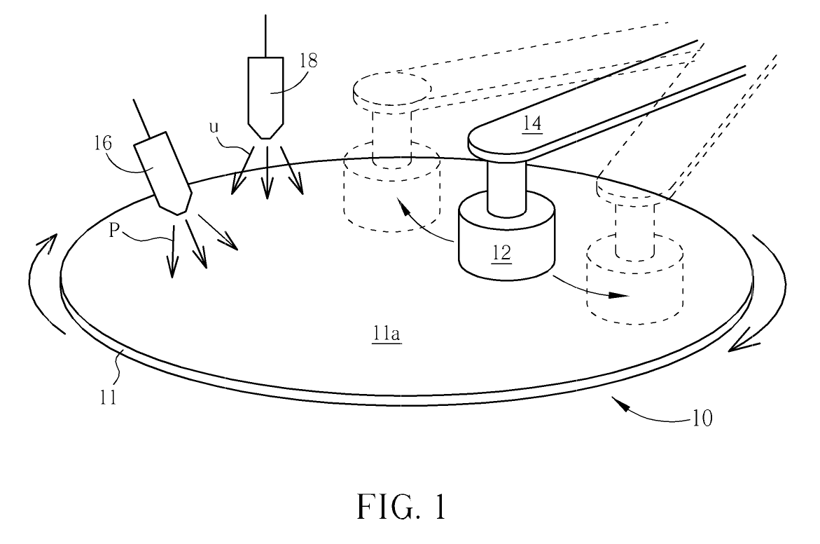

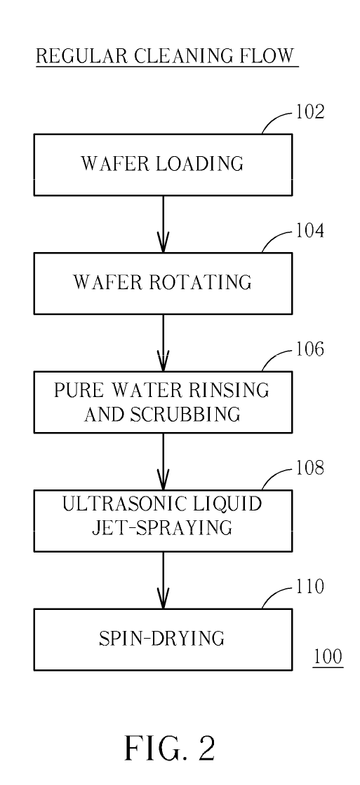

Please refer to FIG. 1 and FIG. 2. FIG. 1 is a schematic diagram illustrating parts of an exemplary scrubber for cleaning a surface of a semiconductor wafer, which are germane to this invention. FIG. 2 is a flow chart showing a regular cleaning flow for cleaning the semiconductor wafer in accordance with one embodiment of this invention. According to the embodiment of the invention, the aforesaid regular cleaning flow is not implemented unless the newly replaced sponge of PVA itself is in a good and clean condition. As shown in FIG. 1 and FIG. 2, the regular cleaning flow 100 can be implemented in a scrubber 10 or any similar wafer cleaning apparatuses. The regular cleaning flow 100 includes multiple steps, some of which may be performed independently or simultaneously. In Step 102, a semiconductor wafer 11 having a surface 11a to be cleaned is loaded into the scrubber 10. The semiconductor wafer 11 may be subjected to a chemical mechanical polishing (CMP) process before undergoing the regular cleaning flow 100. In the scrubber, the semiconductor wafer 11 may be supported by a wafer support means such as wafer holder stage, chuck, rollers or any suitable ways. In Step 104, the semiconductor wafer 11 is rotated at a pre-set speed, for example, 1000˜5000 rpm. In Step 106, the sponge of PVA 12, which is connected to an arm 14 that is capable of swinging along a pre-set route, is pressed against the surface 11a to be cleaned of the semiconductor wafer 11 to scrub the rotating semiconductor wafer 11. The sponge of PVA 12 may be rotated about it center axis in some cases. Simultaneously, the surface 11a to be cleaned may be rinsed by spraying pure water P thereto through a nozzle 16. In Step 108, optionally, a jet spray of liquid such as pure water U, which is excited by ultrasonic vibration energy from a nozzle 18, is started. In Step 110, the semiconductor wafer 11 is rotated at high speed to be spin-dried and thereby the regular cleaning flow is completed.

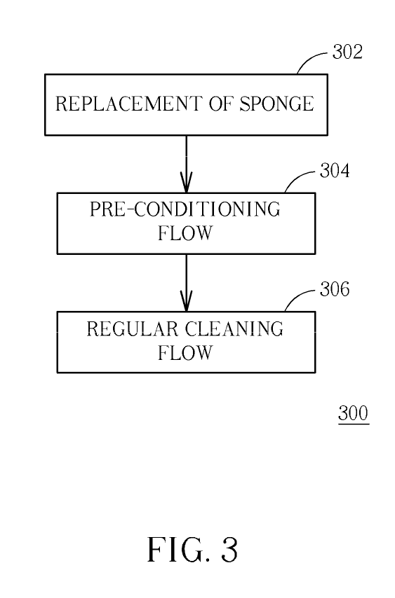

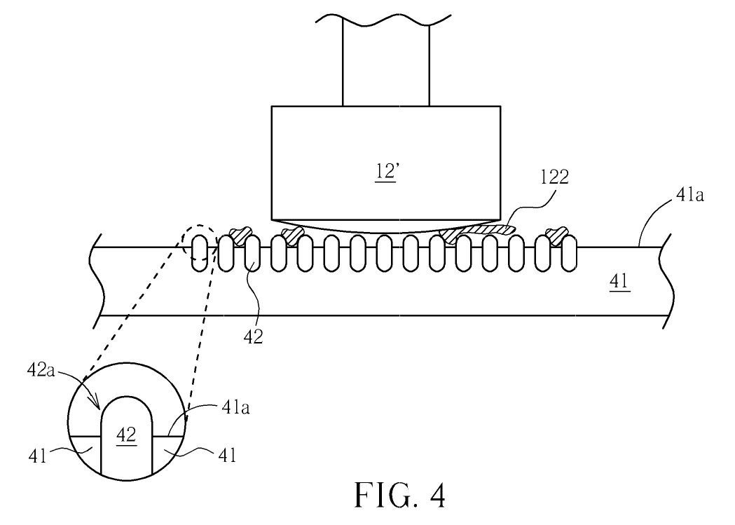

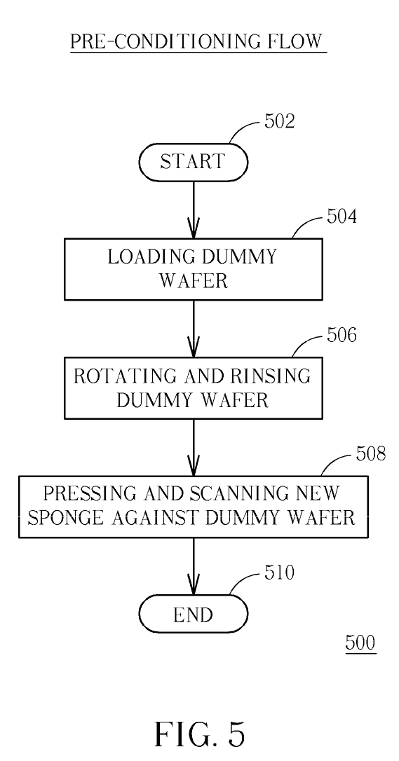

Please refer to FIG. 3 to FIG. 5. FIG. 3 is a flow chart showing a wafer cleaning method particularly suited for a scrubber having a newly replaced sponge of PVA in accordance with one preferred embodiment of this invention. FIG. 4 is a schematic, cross-sectional diagram illustrating the pre-conditioning status of a newly replaced sponge of PVA using a specific dummy wafer in accordance with the preferred embodiment of this invention. FIG. 5 is a flow chart showing an exemplary pre-conditioning flow in accordance with the preferred embodiment of this invention. As shown in FIG. 3 and FIG. 4, the wafer cleaning method according to this invention generally includes three steps. In Step 302, the sponge 12 as depicted in FIG. 1 is removed and replaced with a new sponge 12′ as depicted in FIG. 4. It is believed that the new sponge of PVA has thereon a plurality of residual fibers 122 or contaminants, which would influence the performance of the wafer scrubbing cleaning process. In Step 302, the new sponge 12′ is pre-conditioned using a specific dummy wafer 41 to remove the residual fiber 122 or contaminants from the surface of the new sponge 12′. In Step 304, after the pre-conditioning flow implemented on the new sponge 12′ is completed, the dummy wafer 41 is removed and unloaded from the scrubber 10 as depicted in FIG. 1. In Step 306, a semiconductor wafer to be cleaned is then loaded into the scrubber 10 and a regular cleaning flow as described in FIG. 2 is carried out.

Referring to FIG. 4 and FIG. 5, an exemplary pre-conditioning flow 500 in accordance with the preferred embodiment will now be explained in detail. It is understood that the steps exemplary pre-conditioning flow 500 in the may be performed independently or simultaneously. The sequence of the steps may be different in other embodiments. As shown in FIG. 4 and FIG. 5, the pre-conditioning flow 500 may be triggered upon the replacement of the sponge (or brush) of the scrubber (Step 502). Once the pre-conditioning flow 500 is triggered, a dummy wafer 41 having an irregular topography on the surface 41a to be in direct contact with the new sponge 12′ is loaded into the scrubber 10 and is held by the wafer holder stage, vacuum chuck, rollers or any suitable means (Step 504). The dummy wafer 41 is rotated at a pre-set speed, for example, 1000˜5000 rpm, and may be rinsed by spraying pure water onto the surface 41a (Step 506). The new sponge 12′ is pressed against the surface 41a of the dummy wafer 41. Likewise, the new sponge 12′ is connected to the arm 14 and is swung along a pre-set scanning and reciprocating route such that the upward protruding features 42 on the surface 41a can remove the residual fibers 122 or unwanted substances from the surface of the new sponge 12′ (Step 508). Subsequently, the new sponge 12′ is detached from the dummy wafer 41 and the dummy wafer 41 is unloaded from the scrubber 10 (Step 510). The scrubber 10 is then ready for the product wafers.

A schematic enlarged view of the upward protruding feature 42 is shown in the lower circle area of FIG. 4. According to the preferred embodiment of the invention, each of the upward protruding features 42 has an upper round corner 42a to prevent damage to the new sponge 12′. Preferably, the upward protruding features 42 may be arranged in an array and may be in a closed packed pattern with space or gaps between the upward protruding features 42. For example, the upward protruding features 42 may be shallow trench isolation (STI) regions fabricated in a DRAM cell array on a discarded wafer, but not limited thereto. The residual fibers 122 or unwanted substances may be retained within the space or gaps between the upward protruding features 42 and does not contaminate the new sponge 12′ again.

Those skilled in the art will readily observe that numerous modifications and alterations of the device and method may be made while retaining the teachings of the invention.

1. A wafer cleaning method, comprising:
providing a wafer cleaning apparatus comprising a used sponge for scrubbing a surface of a semiconductor wafer to be cleaned;
replacing the used sponge with a new sponge;
implementing a pre-conditioning flow to pre-condition the new sponge using a dummy wafer; and
performing a regular cleaning flow to scrub the surface of the semiconductor wafer to be cleaned using the pre-conditioned sponge.

2. The wafer cleaning method according to claim 1 wherein the wafer cleaning apparatus comprises a scrubber.

3. The wafer cleaning method according to claim 2 wherein the scrubber comprises a wafer support means.

4. The wafer cleaning method according to claim 2 wherein the scrubber comprises an arm connected to the sponge, and wherein the arm is capable of swinging the sponge along a scanning and reciprocating route.

5. The wafer cleaning method according to claim 1 wherein the pre-conditioning flow comprises:
loading the dummy wafer into the wafer cleaning apparatus;
rotating and rinsing the dummy wafer; and
pressing and scanning the sponge against the dummy wafer.

6. The wafer cleaning method according to claim 1 wherein the dummy wafer has a plurality of upward protruding features on a surface of the dummy wafer for removing residual fibers or unwanted substances from the sponge.

7. The wafer cleaning method according to claim 6 wherein the upward protruding features are arranged in an array and are in a closed packed pattern with gaps between the upward protruding features.

8. The wafer cleaning method according to claim 6 wherein the upward protruding features comprise shallow trench isolation (STI) regions fabricated in a DRAM cell array on a discarded wafer.

9. The wafer cleaning method according to claim 6 wherein each of the upward protruding features has an upper round corner to prevent damage to the sponge.

10. The wafer cleaning method according to claim 1 wherein the sponge comprises polyvinyl acetate (PVA).
